(19) United States
(12) Patent Application Publication
(10) Pub. No.: US 2006/0287814 A1
(43) Pub. Date: Dec. 21, 2006

(54) NAVIGATION SYSTEM FOR DISPLAYING DIRECTION INFORMATION TO DESTINATION, AND METHOD THEREOF

(76) Inventor: Soo Sean Lee, Icheon-shi (KR)

Correspondence Address: IPLA P.A., 3580 WILSHIRE BLVD., 17TH FLOOR, LOS ANGELES, CA, 90010, US

(21) Appl. No.: 11/277,709

(22) Filed: Mar. 28, 2006

(30) Foreign Application Priority Data
May 3, 2005 (KR) 10-2005-0036981

(51) Int. Cl. G01C 21/32; G01C 21/30

(52) U.S. Cl. 701/208

(57) ABSTRACT

A navigation system for displaying information on a straight-lined direction from a current position to a destination, and a method thereof are provided. The system includes a GPS module for measuring current position and running direction of a vehicle, and generating information on the current position and running direction; a controller for receiving the information on the current position and running direction, deciding a direction of a destination inputted by a user at the current position, generating information on the decided destination direction, and outputting the generated destination direction information to a display unit; and the display unit for receiving the destination direction information and displaying the received destination direction information together with map data.

### BACKGROUND OF THE INVENTION

1. Field of the Invention

The present invention relates to a navigation system, and more particularly, to a navigation system for displaying information on a straight-lined direction from a current position to a destination, and a method thereof.

2. Description of the Related Art

In general, a navigation system refers to a system for mapping current position and direction information measured in a GPS system to map data, displaying the mapped current position and direction information, receiving a destination from a user, setting and displaying a path to the destination on the basis of the map data according to a preset path selection method, comparing a continuously updated current position with the path, and guiding the path.

In general, a user sets a map scale to a 100× to 400× magnification for use in many cases, in order not to get out of the guided path. However, on a road having many intersections and having many left/right turns and U-turns on the guided path as in a downtown, it is difficult to confirm whether a destination is in any direction (East, West, South, or North) of a current position. Accordingly, the user should change the scale map in order to confirm whether the destination is in any direction of the current position.

As described above, the conventional navigation system has a drawback in that, since the user has a difficulty in recognizing the destination direction, he/she may be doubtful of whether or not to be on a right path.

Further, the conventional navigation system has a drawback in that the user should directly manipulate the navigation system and change the scale map with his/her inconvenience, in order to confirm the destination direction.

Furthermore, the conventional navigation system has a drawback in that, since the user should directly manipulate the navigation system while driving a car, he/she de-concentrates on the driving and therefore, causes a traffic accident.

### SUMMARY OF THE INVENTION

Accordingly, the present invention is directed to a navigation system for displaying direction information to a destination and a method thereof that substantially overcome one or more of the limitations and disadvantages of the conventional art.

One object of the present invention is to provide a navigation system for displaying whether a destination is in any direction of a current position, and a method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a navigation system for displaying destination direction information, the system including: a GPS module for measuring current position and running direction of a vehicle, and generating information on the current position and running direction; a controller for receiving the information on the current position and running direction, deciding a direction of a destination inputted by a user at the current position, generating information on the decided destination direction, and outputting the generated destination direction information to a display unit; and the display unit for receiving the destination direction information and displaying the received destination direction information together with map data.

In another aspect of the present invention, there is provided a method for displaying destination direction information in a navigation system, the method including the steps of: measuring current position and running direction of a vehicle, and generating information on the current position and running direction; receiving the information on the current position and running direction, and deciding a direction of a destination inputted by a user at the current position; and displaying the destination direction information together with map data.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is a block diagram illustrating a construction of a navigation system according to the present invention;

FIG. 2 is a flowchart illustrating a method for displaying direction information to a destination according to an embodiment of the present invention;

FIG. 3 illustrates a map screen in which direction information to a destination is mapped to map data according to an embodiment of the present invention; and

FIG. 4 illustrates a method for calculating an angle between a current position and a destination according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

The present invention measures current position and direction, calculates an angle between the direction-based current position and a destination inputted by a user, using the measured current position and direction information and coordinate information of the destination, and displays whether the destination is in any direction on the basis of the calculated angle.

Hereinafter, a construction and an operation of the navigation system for displaying a direction from the current position to the destination will be described, and a method for displaying the direction will be described with reference to the attached drawings.

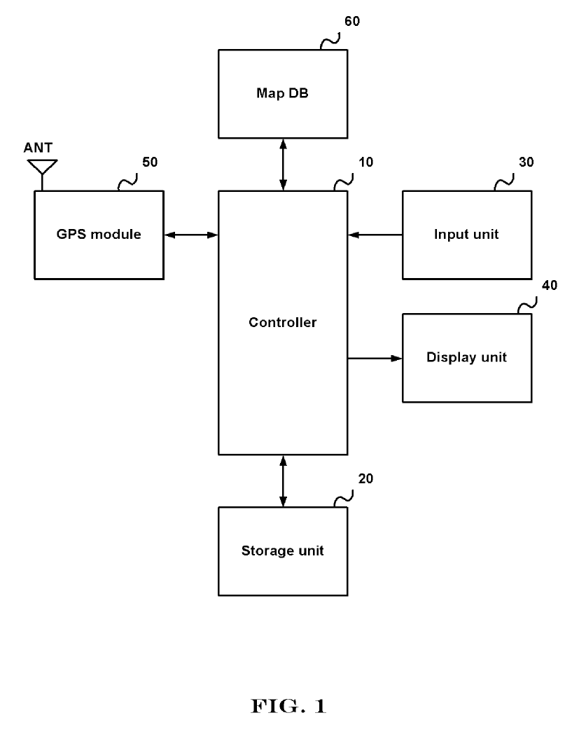

FIG. 1 is a block diagram illustrating a construction of a navigation system according to the present invention.

Referring to FIG. 1, the inventive navigation system includes a controller 10, a storage unit 20, an input unit 30, a display unit 40, and a global positioning system (GPS) module 50.

The controller 10 controls a general operation of the navigation system. In particular, the controller 10 receives the current position and direction information, and calculates the angle for displaying whether the destination is in any direction of the direction-based current position.

The storage unit 20 includes a region for storing a control program for controlling an operation of the navigation system, a region for temporarily storing data generated in execution of the control program, and a region for storing the position and direction information, and various setting values set by the user such as determination whether a map on-screen method employs a North-fixed display method or a vehicle-reference display method. Specifically, the storage unit 20 stores the angle calculated by the controller 10.

The input unit 30 includes a plurality of keys for controlling a function and an operation of the navigation system, and generates data on the keys.

The display unit 40 displays operation state information of the navigation system and map data obtained by mapping the current position and direction and a path, and displays the direction from the current position to the destination according to the present invention.

The GPS module 50 receives each position information from a plurality of global positioning system (GPS) satellites, calculates the current position from the position information, measures the current running direction using a gyro sensor, and outputs the calculated current position and direction information to the controller 10.

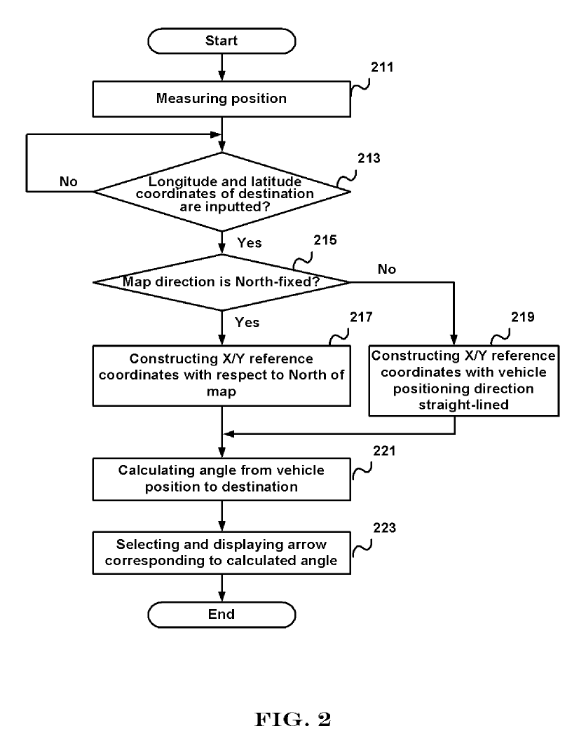

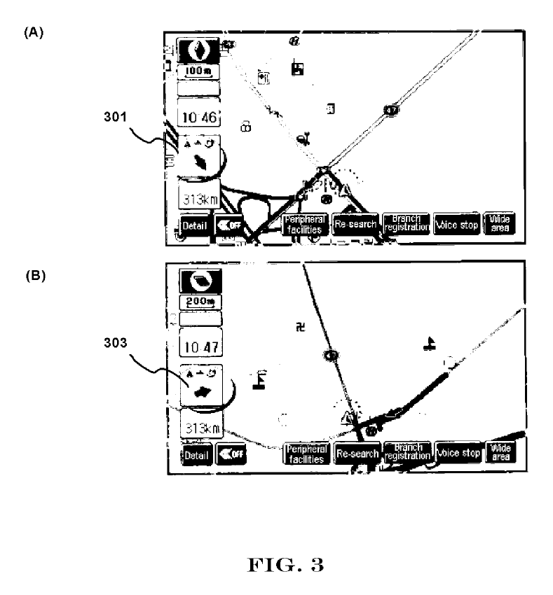

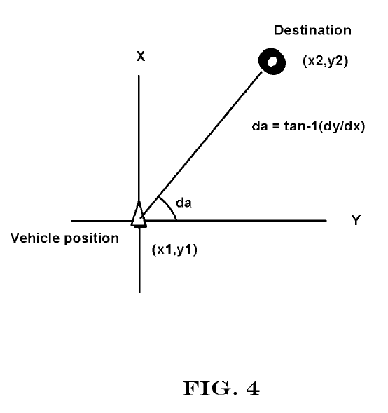

FIG. 2 is a flowchart illustrating a method for displaying the direction information to the destination according to an embodiment of the present invention, FIG. 3 illustrates a map screen in which the direction information to the destination is mapped to the map data according to an embodiment of the present invention, and FIG. 4 illustrates a method for calculating the angle between the current position and the destination according to the present invention.

Hereinafter, a description will be made with reference to FIGS. 1 to 4.

First, if a power source is supplied to the navigation system, the controller 10 measures the current position and direction through the GPS module 50 in Step 211, and checks whether or not longitude/latitude of the destination are inputted in Step 213. That is, it checks whether or not the destination is inputted. Upon receipt of information on the measured current position and direction and the destination from the GPS module 50, the controller 10 checks the setting values of the storage unit 20, and determines whether or not a map direction is based on a North-fixed scheme in Step 213. If it is determined as the determination result to be based on the North-fixed scheme, the controller 10 proceeds with Step 217. If it is determined as the determination result to be based on a vehicle reference scheme, the controller 10 proceeds with Step 219.

In the Step 217, the controller 10 constructs a screen based on X/Y reference coordinates with respect to North of a map. In the Step 219, the controller 10 constructs a screen based on X/Y reference coordinates with a vehicle positioning direction straight-lined.

Upon constructing of the reference coordinates in the Step 217 or 219, the controller 10 calculates the angle from the current position to the destination in Step 221. The angle is calculated as in FIG. 4 by the following Equation:

[Equation]
da=tan⁻¹(dy/dx)

where

da: direction from direction-based current position to destination, that is, angle between X-axis and straight-line connecting from current position to destination,

dy: Y-coordinate variation between current position (x1, y1) and destination (x2, y2), and

dx: X-coordinate variation between current position (x1, y1) and destination (x2, y2).

In case where the reference coordinate of the map displayed on the screen is constructed in the Step 217, it does not need to consider the direction of the vehicle. However, in case where the reference coordinate with the vehicle positioning direction straight-lined is constructed in the Step 219, the direction of the vehicle should be considered.

For example, when the current position of the vehicle is at a coordinate of (0,0) and the destination is at a coordinate of (5, 10), the da is an angle of 63.43° obtained from the Equation. However, if the running direction of the vehicle is changed to the direction of the X-axis of FIG. 4, the X-axis becomes a Y-axis, and vice versa. Therefore, the da is an angle of −63.43° or 296.57°.

Upon calculation of the angle in the Step 221, the controller 10 selects and displays an arrow corresponding to the calculated angle in Step 223. The arrow can be displayed at a separate display region allocated to one side of the screen as indicated by reference numerals 301 and 303 of FIGS. 3A and 3B. In the present invention, the destination direction is fractionized into and displayed in sixteen directions, but can be also fractionized into greater directions.

As described above, the present invention has an advantage in that, since the destination direction is displayed at the current position, even when a path having a lot of intersections, ramps, and U-turns is guided, it can be clearly confirmed whether the destination is in any direction, thereby providing convenience to a driver.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. A navigation system for displaying destination direction information, the system comprising:
a GPS module for measuring current position and running direction of a vehicle, and generating information on the current position and running direction;
a controller for receiving the information on the current position and running direction, deciding a direction of a destination inputted by a user at the current position, generating information on the decided destination direction, and outputting the generated destination direction information to a display unit; and
the display unit for receiving the destination direction information and displaying the received destination direction information together with map data.

2. The system according to claim 1, wherein the destination direction information is an angle between a horizontal line including a coordinate of the current position and a straight-line connecting the coordinate of the current position and a destination coordinate.

3. The system according to claim 2, wherein the angle is calculated in the following Equation:
da=tan⁻¹(dy/dx)
where,
da: direction from direction-based current position to destination, that is, angle between X-axis and straight-line connecting from current position to destination,
dy: Y-coordinate variation between current position (x1, y1) and destination (x2, y2), and
dx: X-coordinate variation between current position (x1, y1) and destination (x2, y2).

4. The system according to claim 3, wherein, if the map data is constructed by a reference coordinate with a vehicle positioning direction straight-lined, the angle is calculated considering the running direction.

5. A method for displaying destination direction information in a navigation system, the method comprising the steps of:
measuring current position and running direction of a vehicle, and generating information on the current position and running direction;
receiving the information on the current position and running direction, and deciding a direction of a destination inputted by a user at the current position; and
displaying the destination direction information together with map data.

6. The method according to claim 5, wherein the destination direction information is an angle between a horizontal line including a coordinate of the current position and a straight-line connecting the coordinate of the current position and a destination coordinate.

7. The method according to claim 6, wherein the angle is calculated in the following Equation:
da=tan⁻¹(dy/dx)
where,
da: direction from direction-based current position to destination, that is, angle between X-axis and straight-line connecting from current position to destination,
dy: Y-coordinate variation between current position (x1, y1) and destination (x2, y2), and
dx: X-coordinate variation between current position (x1, y1) and destination (x2, y2).

8. The method according to claim 7, wherein, if the map data is constructed by a reference coordinate with a vehicle positioning direction straight-lined, the angle is calculated considering the running direction.
